(19) United States
(12) Patent Application Publication
(10) Pub. No.: US 2008/0083712 A1
(43) Pub. Date: Apr. 10, 2008

(54) Inductively-coupled plasma torch

(76) Inventors: Hiroaki Tao, Ibaraki (JP); Tetsuya Nakazato, Ibaraki (JP); Kenichi Sakata, Tokyo (JP)

Correspondence Address: Paul D. Greeley;Ohlandt, Greeley, Ruggiero & Perle, L.L.P., 10th Floor, One Landmark Square, Stamford, CT, 06901-2682, US

(21) Appl. No.: 11/637,547

(22) Filed: Dec. 12, 2006

(30) Foreign Application Priority Data
Jan. 16, 2006 (JP) 2006-7673

(51) Int. Cl. B23K 9/00

(52) U.S. Cl. 219/121.52

(57) ABSTRACT

To provide an inductively-coupled plasma torch capable of holding a capillary tube coaxially with a make-up gas tube stably and easily, smoothly conveying make-up gas and easily adjusting the axial position of the capillary tube downstream end portion.

An inductively-coupled plasma torch assembly comprising a make-up gas tube (3) accepting a capillary tube (4) for introducing a gaseous sample so as to surround the capillary tube to allow the make-up gas to pass the space between the capillary tube and the make-up gas tube, a cylindrical member externally heating the make-up gas tube, and torch bodies (7, 8) for supporting the cylindrical member, and being provided with a positioning member (15) for positioning the capillary tube in the radial direction on the downstream end portion side of the cylindrical member, wherein the positioning member is fixed to the downstream end portion of the cylindrical member.

### FIELD OF THE INVENTION

The present invention relates to a torch for introducing high-boiling point gaseous molecules into inductively-coupled plasma. In particular, the present invention relates to a torch for effectively introducing high-boiling point gaseous molecules into the center portion of inductively-coupled plasma without cooling and condensing the high-boiling point gaseous molecules, when high-boiling point gaseous molecules, that is, a high boiling point sample to be analyzed in a gaseous molecule state provided from a high temperature source such as a gas chromatograph (GC), a pyrolyzer or a thermogravimeter (TG) is introduced into inductively-coupled plasma (ICP) of an inorganic element analyzer upon carrying out analysis by an inductively-coupled plasma atomic emission spectroscopy (ICP-AES) or an inductively-coupled plasma mass spectroscopy (ICP-MS).

### RELATED ARTS

Conventionally, in order to introduce high-boiling point gaseous molecules provided from a high temperature source such as a gas chromatograph (GC), a pyrolyzer or a thermogravimeter (TG) into inductively-coupled plasma, one having a type has been often used, in which only a sample-introducing tube between the outlet of a GC, a pyrolyzer or a TG and the inlet of an inductively-coupled plasma torch is electrically heated to a high temperature with a nichrome wire or the like and, on the other hand, a sample-introducing tube inside the inductively-coupled plasma torch is intended to be kept at a high temperature through thermal conduction from an external sample-introducing tube without being heated electrically (for example, refer to A. W. Kim, M. E. Foulkes, L. Ebdon, S. J. Hill, R. L. Patience, A. G. Barwise, S. J. Rowland: J. Anal. At. Spectrom., 7, 1147-1149 (1992), FIG. 1).

Further, one having a type is also used, in which not only a sample-introducing tube between the outlet of a GC, a pyrolyzer or a TG and the inlet of an inductively-coupled plasma torch, but also a sample-introducing tube inside the inductively-coupled plasma torch are heated by electric-resistance heating of a metallic sample-introducing tube by directly electrifying the tube (for example, refer to L. Ebdon, E. H. Evans, W. G. Pretorius, S. J. Rowland: J. Anal. At. Spectrom., 9, 939-943 (1994), FIG. 1).

However, for conventional apparatuses of these types, it has been difficult to set a sample-introducing tube on the central axis of the inductively-coupled plasma torch, that is, coaxially with it. For this reason, there has been a problem that, when high-boiling compounds out of the sample-introducing tube are not introduced into the center of inductively-coupled plasma, the sensitivity or accuracy of analysis deteriorates.

In order to solve such problems, the present inventors have already proposed inventions (refer to JP-B 2931967 and JP-B 3118567). Each of these has such structure that a capillary tube is coaxially disposed in the inside of a sample-introducing tube composed of a metallic tube, that is, a make-up gas tube to convey make-up gas between the capillary tube and the sample-introducing tube. However, in such structure, it is considered that the position of the capillary tube changes relative to the inductively-coupled plasma torch to result in a large variation of analytical sensitivity and accuracy. Consequently, in the case of JP-B 2931967, a part for coaxially arranging a capillary tube to a sample-introducing tube is provided, but the part has such problem that it easily breaks. In the case of JP-B 3118567, since such part is not provided and a capillary tube easily moves in an injector tube by pressure of the make-up gas, there is such problem that accurate adjustment of the position of the capillary tube in the axial direction is difficult.

The structure in JP-A 2004-158314 includes a guide held near the downstream end portion of an injector tube, the guide having a through hole for coaxially holding a capillary tube relative to the injector tube and a means for allowing a make-up gas to pass through. This structure particularly effectively acts when the injector tube is formed of an inorganic material such as silica glass and a metallic sample-introducing tube in which the capillary tube is coaxially disposed, that is, a make-up gas tube is arranged in the inside. However, there is such problem that the injector tube easily breaks. On the other hand, when an injector tube is composed of a metallic material such as stainless steel, although the function as a guide is fully exerted, it has a rather redundant structure. Further, in each case, a work of inserting the guide in the vicinity of the downstream end portion of the injector tube and positioning the same is troublesome.

### SUMMARY OF THE INVENTION

Consequently, the present invention aims to provide an inductively-coupled plasma torch that conveys make-up gas smoothly while holding a capillary tube with a make-up gas tube coaxially, stably and easily, and is capable of easily adjusting the position of the downstream end portion of the capillary tube in the axial direction, when an injector tube is particularly composed of a metallic material.

The above problems are solved by an inductively-coupled plasma torch, wherein an inductively-coupled plasma torch assembly comprises:

a make-up gas tube accepting a capillary tube for introducing a gaseous sample, so as to surround the capillary tube to allow make-up gas to pass through the space between the capillary tube and the make-up gas tube;

a cylindrical member for externally heating the make-up gas tube; and

a torch body for supporting the cylindrical member, the inductively-coupled plasma torch assembly being provided with a positioning member for positioning the capillary tube in the radial direction on the downstream end side of the cylindrical member while allowing the make-up gas to pass through, and

wherein the positioning member is fixed to the downstream end portion of the cylindrical member.

The cylindrical member can be composed of a metallic thermal homogenizing pipe coaxially provided in the torch body, in which case the make-up gas tube is coaxially provided in the thermal homogenizing pipe. The thermal homogenizing pipe is composed of a heater wire and a temperature sensor, and an additional thermal homogenizing material or filling material as needed. Alternatively, the thermal homogenizing pipe may be composed of a heat pipe. In this case, the heat pipe may be so designed that a make-up gas tube is laid through a through hole provided through the center of the heat pipe, or that the through hole itself is formed as the make-up gas tube. By providing and arranging a capillary tube and a make-up gas tube integrally with a thermal homogenizing pipe in the torch body as stated above, high-boiling point gaseous molecules may be conveyed to inductively-coupled plasma without condensing within a temperature range, e.g., from room temperature to a high-temperature region of 400° C.

The positioning member for positioning the capillary tube in the radial direction can be a guide, for example, having a cylinder-like shape (including a disc-like shape). The guide has a through hole for allowing the capillary tube to penetrate at the central portion thereof. In addition to the through hole, it has a passage groove or a passage hole for conveying make-up gas. The positioning member is mounted and fixed to the downstream end portion of the cylindrical member to hold the capillary tube coaxially to the cylindrical member and also to the make-up gas tube coaxially with the cylindrical member. Thus, it becomes possible to introduce a high-boiling point sample being introduced from the capillary tube into plasma stably with a high efficiency, and the make-up gas also flows smoothly to the downstream end portion of the injector tube. The opening for the make-up gas provided at the positioning member is preferably a passage hole positioned at least at the intermediate position in the radial direction.

Preferably, the positioning member is detachably fixed to the downstream end portion of the cylindrical member. Such fixing can be achieved by a cap member mounted to the downstream end portion of the cylindrical member. Such structure is preferable that the downstream end portion of the cylindrical member consists of a metal material such as stainless steel, and that also the cap member consists of a similar material. In this case, it is possible to constitute the downstream end portion of the cylindrical member separately from the body portion and fix it integrally. Such constitution is preferable in manufacturing when the downstream end portion of the cylindrical member is formed in a shape fitting with the positioning member or the cap member.

The cap member can be mounted to the downstream end portion of the cylindrical member by a mechanical means such as screwing or press fitting. In this case, the positioning member can be previously held by the cap member, wherein it is easy to arrange the positioning member to a small metallic cap member, compared with a conventional way in which a positioning member (guide) is inserted near the downstream end portion of an injector tube and positioned. Holding of the positioning member in the cap member can be achieved, for example, by screwing or press-fitting of the positioning member, or use of a ring. Alternatively, the positioning member can be fixed to the downstream end portion of the cylindrical member by sandwiching it between the downstream end portion of the cylindrical member and the cap member when the cap member is mounted to the downstream end portion of the cylindrical member.

The cap member preferably has an outer diameter not exceeding that of the cylindrical member, which is intended not to disturb the flow of the gas around the injector tube. Incidentally, the cap member may be mounted to the downstream end portion of the cylindrical member by welding or the like.

By making the through hole of the positioning member have a diameter slightly larger than the outer diameter of the capillary tube, the outer surface of the capillary tube can be substantially attached firmly to the surface of the through hole. The make-up gas does not substantially flow through the firmly attached portion of the guide and the capillary tube. The use of the positioning member allows the capillary tube to be held on the central axis of the injector tube, that is, coaxially with the injector tube, stably and easily. Further, in order to maintain a relative position of the positioning member to the axial direction of the capillary tube, it is also possible to provide a member for preventing an axial displacement engaging with both of the capillary tube and the positioning member.

### BRIEF DESCRIPTION OF THE DRAWINGS

FIG. 1(a) shows an axial cross-section of the entire inductively-coupled plasma torch of the present invention, and FIGS. 1(b) and 1(c) are an enlarged cross-sectional views showing the detail of an example of a downstream end portion 17 of an injector tube body 18 and the cross-section taken along the A-A line, respectively.

FIGS. 2(a) and 2(b) are cross-sectional views similar to FIGS. 1(b) and (c), respectively, showing the detail of another example of a downstream end portion 17 of an injector tube body 18.

FIG. 3 is a cross-sectional view similar to FIG. 1(b), showing the detail of another example of a downstream end portion 17 of an injector tube body 18.

In the drawings, numerical references are:

1: Heater wire, 2: Temperature sensor, 3: Metallic tube for make-up gas, 4: Capillary tube for introducing a sample, 5: Metallic pipe, 6: Metallic plug, 7: Outermost tube of an inductively-coupled plasma torch, 8: Central tube of an inductively-coupled plasma torch, 9: Connecter with a ball joint, 10: Connecter, 11: Metallic tube coming from a high-temperature source, 12: Thermal homogenizing material, 13, 14: Ring, 15: Positioning member, 16: Cap, 17: Injector tube downstream end portion, 18: Injector tube body, 19: End guide portion, 20: Outermost end portion, 21: Make-up gas flow path, 22: Induction coil, 23, 24: Axial positioning member.

### DETAILED EXPLANATION OF THE INVENTION

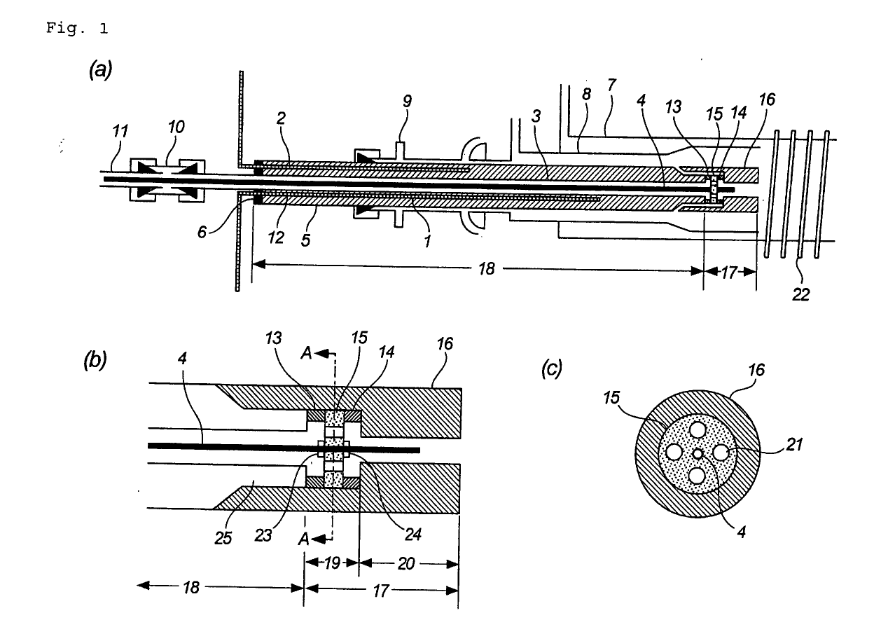

With reference to the attached drawings, the present invention will be described in further detail. FIG. 1 is a general cross-sectional view showing an inductively-coupled plasma torch of the present invention. FIG. 1(a) shows the whole of the inductively-coupled plasma torch, FIG. 1(b) shows an enlarged cross-sectional view of the downstream end portion in FIG. 1(a), and FIG. 1(c) shows a cross-sectional view taken along the A-A line in FIG. 1(b). A metallic make-up gas tube 3 for conveying make-up gas such as argon (Ar) gas accepts, in the inside thereof, a capillary tube 4 for introducing gaseous molecules of a sample to be analyzed so as to surrounding it. Therefore, the make-up gas tube 3 also has a function for protecting the capillary tube 4 not to be damaged. In the example shown here, the make-up gas tube 3 and the capillary tube 4 are housed in a thermal homogenizing pipe 5 constituted of a heater wire 1, a temperature sensor 2 and a thermal homogenizing material 12. The pipe 5 itself is formed of a metallic material such as stainless steel to constitute a cylindrical member for externally heating the make-up gas tube. The thermal homogenizing material 12 consists of, for example, ceramic powders, glass beads, or short cut metal wires.

The end portion of the metallic pipe 5 is sealed with a metallic plug 6, and the make-up gas tube 3, the capillary tube 4 and the temperature homogenizing metallic pipe 5 are integrated to constitute an injector tube body 18. As the metallic pipe 5, one having an outer diameter of, for example, 3 to 6 mm may be used. The injector tube body 18 is connected with a torch body including an outermost tube 7 and a central tube 8 so as to be adjustable in an angle and an axial position by using a connecter 9 having a ball joint. The make-up gas tube 3 extends from the metallic plug 6 and is connected with a metallic tube 11 from a high temperature source by a connecter 10. At the connecting portion also, heating and heat-retention are carried out by a conventionally publicly known method to inhibit condensation of the high-boiling point compound. At the end face on the opposite side to the metallic plug 6, the injector tube body 18 ends with a downstream end portion 25 formed in a tapered shape.

To the downstream end portion 25, a metallic cap 16 having an interior shape complementary to an exterior shape of the downstream end portion is press-fitted, and there is sandwiched a positioning member 15 between them so as to be coaxial with the injector tube body 18. Consequently, the positioning member 15 is fixed to and held by a cylindrical member, that is, here the downstream end portion 25 of the injector tube body 18. The cap 16 has an outer diameter approximately the same as that of the injector tube body 18 to constitute the downstream end portion 17 of the injector tube. Incidentally, it is also possible to constitute the downstream end portion 25 separately from remaining portions of the injector tube body 18, which is fixated with silver solder or a heat-resistant ceramic adhesive to be integrated, thereby forming the injector tube body 18.

On both sides in the axial direction of the positioning member 15, there are arranged rings 13 and 14 made of, for example, metal, to work so that the positioning member 15 does not shift in the axial direction. However, when the positioning member 15 is held in the inside of the cap 16 by press fitting, the ring may not be used. The positioning member 15 has a through hole for holding the capillary tube 4 at the center thereof, to hold the capillary tube 4 so as to be coaxial with the injector tube body 18. When the through hole of the positioning member 15 has a diameter slightly larger than the outer diameter of the capillary tube 4, the outer surface of the capillary tube 4 penetrates the positioning member 15 while substantially sticking fast with the inner surface of the through hole.

Further, the positioning member 15 is provided with a flow path 21 composed of an axial through hole, for allowing a make-up gas to pass. Owing to this, the make-up gas conveyed in the make-up gas tube 3 passes the flow path 21 of the positioning member 15 at a guide portion 19, which interflows with a carrier gas conveyed in the capillary tube 4 at an outermost edge portion 20 of the injector tube, thereby smoothly conveying the gaseous molecules to the central portion of inductively-coupled plasma. In addition, in the illustrated example, there are disposed members for preventing an axial displacement 23, 24 engaging with both of the capillary tube 4 and the positioning member 15 and maintaining relative position of the positioning member 15 to the axial direction of the capillary tube 4.

The positioning member 15 can be constituted of metal such as stainless steel that makes simple processing and easy manufacturing of a clean product possible. Further, it is also possible to manufacture it from other materials being excellent in heat resistance and good in thermal conductivity as well as metal, for example, silica glass, ceramics or the like. As the material for a metallic tube, a metallic plug and a metallic cap, stainless steel can be cited, but other metal or ceramics may also be used when it is heat-resistant and non-corrosive. A specific example of the metallic make-up gas tube 3 includes a stainless steel tube having an outer diameter of around 1 to 2 mm. As the capillary tube 4, there are used silica capillaries or stainless steel capillaries having an inactivated inner surface utilized in gas chromatograph, and capillaries of other materials may be used similarly when they have a high heat resistance and an inactivated inner surface. A specific example of the capillary tube 4 includes a silica capillary having an outer diameter of around 0.5 mm.

In operation, heating by a heater wire 1 is carried out to become a set temperature while measuring temperature with a temperature sensor 2, and the cylindrical member functions so as to externally heat the make-up gas tube 3 while keeping the temperature constant. High-boiling point gaseous molecules provided from a high-temperature source such as a GC, a pyrolyzer or a TG, and carrier gas such as helium (He) gas for conveying the high-boiling point gaseous molecule to inductively-coupled plasma are introduced to the inductively-coupled plasma through the capillary tube 4. Make-up gas passes through the make-up gas tube 3 and is guided in the right direction in the figure via a flow path 21 of the positioning member 15, and interflows with flows of the high-boiling point gaseous molecule and the carrier gas at the downstream end portion 17 of the injector tube, which are introduced to the central portion of plasma generated by an induction coil 22.

On the positioning member 15, heat supplied by thermal conduction from the injector tube body 18 as a cylindrical member, heat supplied by thermal conduction from the high-temperature make-up gas and radiant heat supplied from the inductively-coupled plasma act. Since the size of the positioning member 15 is as small as, for example, 3 to 5 mm of the outer diameter and 1 to 5 mm of the entire length, temperature in the region of an end guide portion 19 virtually does not lower, thereby not resulting in generation of condensation of the high-boiling point compound. Accordingly, it is possible to efficiently introduce high-boiling point gaseous molecules coming from the high-temperature source to the central portion of the inductively-coupled plasma, and, at the same time, to analyze these high-boiling point gaseous molecules with a high sensitivity and accuracy. In this case, in the present invention, setting of the positioning member 15 is easy because the end portion of the injector tube is constituted by the cap 16 as another member, in which the positioning member 15 is housed.

In order to arrange the positioning member 15, the injector tube body 18 housing the metallic make-up gas tube 3, and the capillary tube 4, the positioning member 15 is inserted into and fixed to the cap 16, the capillary tube 4 is inserted into the through hole of the positioning member 15, and then the cap 16 is mounted to the downstream end portion of the injector tube body 18. Alternatively, the cap 16 having the positioning member 15 can be mounted to the downstream end portion of the injector tube body 18, followed by inserting the capillary tube 4 into the through hole at the central portion of the positioning member 15. Incidentally, sensitivity obtained by an inductively-coupled plasma mass spectrometry and an inductively-coupled plasma emission spectrometry varies corresponding to the position of the end of the capillary tube 4.

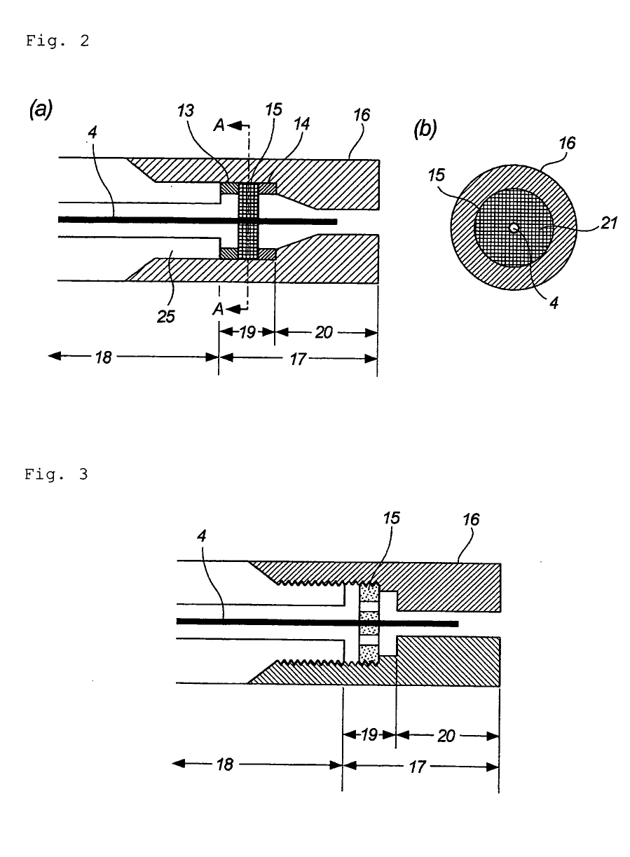

FIG. 2 shows another embodiment of the present invention. In this case, the inside of the cap 16 is constituted with taper from the positioning member 15 to the end, so as to efficiently introduce the flow of the make-up gas, high-boiling point gaseous molecules and the carrier gas to the central portion of plasma as a laminar airflow. In this case also, the positioning member 15 is sandwiched between the cap 16 and the downstream end portion of the injector tube body 18 as the cylindrical member via rings 13 and 14, but, as shown in FIG. 2(b), the positioning member 15 itself is constituted in mesh-like except for the central through hole for the capillary tube 4 and the make-up gas flows through the mesh. Although the cap 16 is mounted detachably to the downstream end portion of the injector tube body 18 by press fitting, fixation by welding is also possible if necessary.

FIG. 3 further shows another embodiment of the present invention. In this example, the inside of the cap 16 is provided with a thread groove, and the periphery of the positioning member 15 is also provided with a corresponding thread groove. Accordingly, the positioning member 15 is housed in the inside of the cap 16 by screwing and fixed mechanically. Further, a similar thread groove is also provided to the downstream end portion of the injector tube body 18, and the cap 16 is fixed to the downstream end portion of the injector tube body 18 by screwing after housing the positioning member 15.

According to the present invention, by fixing the positioning member to the downstream end portion of the cylindrical member, in particular, using the cap member consisting of the same metallic material as the downstream end portion of the cylindrical member, the capillary tube can be positioned at the downstream end portion of the injector tube coaxially with the injector tube with a high accuracy. Consequently, a gas sample of a small amount from the capillary tube can be introduced into the central portion of plasma with a high accuracy, thereby resulting in realizing the stable and highly-sensitive analysis.

Further, when the cap member is constituted detachably, such work as inserting the positioning member into the through hole becomes very easy upon exchanging the capillary tube, thereby making a risk of damaging other part such as the injector tube small. In addition, the use of the member for preventing an axial dislocation can prevent an axial position change between the capillary tube and the positioning member to give a signal strength (sensitivity) with a good reproducibility.

What is claimed is:

1. An inductively-coupled plasma torch, wherein an inductively-coupled plasma torch assembly comprises:
a make-up gas tube accepting a capillary tube for introducing a gaseous sample, so as to surround the capillary tube to allow make-up gas to pass through the space between the capillary tube and the make-up gas tube;
a cylindrical member for externally heating the make-up gas tube; and
a torch body for supporting the cylindrical member, the inductively-coupled plasma torch assembly being provided with a positioning member for positioning the capillary tube in the radial direction on the downstream end side of the cylindrical member while allowing the make-up gas to pass through, and wherein
the positioning member is fixed to the downstream end portion of the cylindrical member.

2. The inductively-coupled plasma torch of claim 1, wherein the positioning member is detachably fixed to the downstream end portion of the cylindrical member by using a cap member.

3. The inductively-coupled plasma torch of claim 2, wherein the cap member is mounted to the downstream end portion of the cylindrical member and the positioning member is sandwiched between the cylindrical member and the cap member.

4. The inductively-coupled plasma torch of claim 2, wherein the cap member is mounted to the downstream end portion of the cylindrical member and the positioning member is held by the cap member.

5. The inductively-coupled plasma torch of claim 2, wherein the cap member is mechanically mounted to the downstream end portion of the cylindrical member by screwing or press fitting.

6. The inductively-coupled plasma torch of claim 2, wherein the cap member has an outer diameter not exceeding that of the cylindrical member.

7. The inductively-coupled plasma torch of claim 1, wherein the positioning member has an opening for allowing the make-up gas to pass through, at least at an intermediate position in the radial direction thereof.

8. The inductively-coupled plasma torch of claim 1, wherein the downstream end portion of the cylindrical member is composed of a metallic material and fixed so as to be integrated with the body of the cylindrical member.

9. The inductively-coupled plasma torch of claim 2, wherein the cap member is composed of a metallic material.

10. The inductively-coupled plasma torch of claim 1, further comprising a member for preventing an axial displacement for maintaining a relative position of the positioning member to the axial direction of the capillary tube, in engagement with the capillary tube and the positioning member.
